(19) United States
(12) Patent Application Publication
(10) Pub. No.: US 2020/0403945 A1
(43) Pub. Date: Dec. 24, 2020

(54) METHODS AND SYSTEMS FOR MANAGING CHATBOTS WITH TIERED SOCIAL DOMAIN ADAPTATION

(71) Applicant: INTERNATIONAL BUSINESS MACHINES CORPORATION, Armonk, NY (US)

(72) Inventors: Stephen BOXWELL, Franklin, OH (US); Stanley VERNIER, Grove City, OH (US); Keith FROST, Delaware, OH (US); Kyle BRAKE, DUBLIN, OH (US)

(73) Assignee: INTERNATIONAL BUSINESS MACHINES CORPORATION, Armonk, NY (US)

(21) Appl. No.: 16/446,263

(22) Filed: Jun. 19, 2019

(51) Int. Cl. H04L 12/58; G06F 16/332; G06F 16/33; G06N 5/02; G06N 3/00

(52) U.S. Cl. CPC H04L 51/02; G06F 16/3329; G06N 3/004; G06N 5/02; G06F 16/3344

(57) ABSTRACT

Embodiments for answering questions utilizing multiple models are described. A plurality of models is received. Each of the plurality of models is associated with answering questions for a respective user. A weighting is assigned to each of the plurality of models. An answer to a question is generated based on the plurality of models and the weighting assigned to each of the plurality of models.

### BACKGROUND OF THE INVENTION

### Field of the Invention

The present invention relates in general to computing systems, and more particularly, to various embodiments for managing chatbots to improve the performance thereof with tiered domain adaptation.

### Description of the Related Art

Chatbots, also known as talkbots, chatterbots, bots, instant messaging (IM) bots, interactive agents, Artificial Conversational Entities (ACEs), etc., are computer nodes (i.e., devices and/or programs) or artificial intelligence modules which are able to conduct conversations with individuals (or users) through auditory (e.g., speech/voice) or text-based methods. Such programs are often designed to convincingly simulate how humans behave as conversational partners. With some chatbot systems (e.g., question answering systems), users may ask questions, and the system answers (or responds) based on its knowledge base and/or by analyzing the question, providing the best answer it can generate.

In some instances, question answering system may be adapted or customized to provide more accurate and/or helpful responses, which may be based on, for example, the particular application, a group of users, or even a specific user. The types of adaptations may include, for example, grammatical rules, synonyms, types of entities associated with queries, and answer filtering (e.g., based on offensive language). However, even in such systems, a user is typically not provided with a way to quickly customize their adaptations based on customizations implemented by other users.

### SUMMARY OF THE INVENTION

Various embodiments for answering questions utilizing multiple models by one or more processors are described. A plurality of models is received. Each of the plurality of models is associated with answering questions for a respective user. A weighting is assigned to each of the plurality of models. An answer to a question is generated based on the plurality of models and the weighting assigned to each of the plurality of models.

In addition to the foregoing exemplary embodiment, various other system and computer program product embodiments are provided and supply related advantages. The foregoing Summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a plan view of a exemplary computing environment according to an embodiment of the present invention; and

FIG. 5 is a flowchart diagram of an exemplary method for answering questions according to an embodiment of the present invention.

### DETAILED DESCRIPTION OF THE DRAWINGS

As discussed above, chatbots, also known as talkbots, chatterbots, bots, instant messaging (IM) bots, interactive agents, Artificial Conversational Entities (ACEs), etc., are computer nodes (i.e., devices and/or programs) or artificial intelligence modules which are able to conduct conversations with individuals (or users) through auditory (e.g., speech/voice) or text-based methods. Such programs are often designed to convincingly simulate how humans behave as conversational partners. With some chatbot systems (e.g., question answering systems), users may ask questions, and the system answers (or responds) based on its knowledge base and/or by analyzing the question, providing the best answer it can generate.

In some instances, question answering systems may be adapted or customized to provide more accurate and/or helpful responses, which may be based on, for example, the particular application, a group of users, or even a specific user. The types of adaptations may include, for example, grammatical rules, synonyms, types of entities associated with queries, and answer filtering (e.g., based on offensive language). This allows for fine-grained domain-adaptation that can respond to, for example, particular question styles and user vocabulary. However, even in such systems, a user is typically not provided with a way to customize their adaptations based on customizations implemented by other users.

For example, consider a workplace environment that utilizes a chatbot that has a question answering functionality (or a question answering system). A new employee, who will not be working in the environment very long, is expected to make use of the system to perform their duties. They are also aware that several other employees have implemented particular adaptations (or domain adaptation models) with their use of the chatbot system. One of the other employees is a manager (or supervisor, etc.) who has customized their system extensively to make use of the appropriate domain “jargon” (e.g., terms of art within the field). Another employee has similarly customized their system with similar jargon and a few inside jokes related to the workplace, but has only been employed at the workplace for a short time (e.g., a month) and may have customized their system in such a way that is not helpful for other users.

The new employee would like to benefit from the customizations of the chatbot system made by the other employees (as well as implement their own customizations). Otherwise, they may have to spend a consider amount of time and effort in tuning the system to work in an optimal manner for their purposes. However, if both sets of customizations (or models) are utilized, given that one of the employees has significantly more experience, there is a chance that the system may provide answers that are not accurate and/or not helpful. In other words, if the system implements all available sets of customizations (e.g., that of the new employee, the manager, and the other employee with little experience), the system may not perform optimally for the new employee.

To address these needs, some embodiments described herein provide methods and systems for managing a chatbot and/or question answering system (and/or the operation thereof) in such a way that the user is able to identify (or select from) one or more available domain adaptation models (or simply “models”) to be utilized by the system when answering questions.

In some embodiments, the user is able to assign a weight (or weighting) to each of the models (e.g., based on a predicted usefulness/helpfulness of each model). The system utilizes a combination of the models and/or uses the models in combination, along with the assigned weights thereof, to generate an answer to a question (or query) submitted by a user (i.e., a primary user).

Each of the models utilized (and/or available to the user) may be associated with a respective user. For example, each model may be (or include) a set of customizations or adaptations that has been created by (or for) a user for their use of the chatbot system. The users may include individuals (e.g., the primary user or other users). However, it should be noted that in some embodiments, the model may be associated with general customizations that have been made in such a way to optimize system operation for a predicted user (e.g., a standard model designed for new or inexperienced users, a default setting, etc.).

In some embodiments, when a question (or query) is received or detected (e.g., via voice command, text-based methods, etc.), the system generates an answer to (or for) the question based on (or utilizing) each of the selected models such that multiple, “preliminary” answers are generated. The system may score (or grade) each of the answers based on the weightings assigned to the models. For example, the system may determine or calculate a “confidence” score (or level, grade, etc.) based on the weightings. The system may select only particular answers based on the scores (e.g., the answer with the highest score, the top few answers, those with a score above a predetermined level, etc.) and provide (or return) those answers to the primary user (i.e., the user who submitted the question). As such, in some embodiments, the models are combined, each according to their weight, to adapt the system to the needs of individual users.

In some embodiments, a cognitive analysis or machine learning technique may be utilized to perform at least some aspects of functionality described herein. In some embodiments, the cognitive analysis includes generating a cognitive profile for the user(s) based on, for example, data sources associated with the user(s). Data sources that be use used to generate a cognitive profile for the user(s) may include any appropriate data sources associated with the user that are accessible by the system (perhaps with the permission or authorization of the user). Examples of such data sources include, but are not limited to, computing systems/devices/nodes (e.g., IoT devices) associated with the user, communication sessions and/or the content (or communications) thereof (e.g., phone calls, video calls, text messaging, emails, in person/face-to-face conversations, etc.), a profile of (or basic information about) the user (e.g., job title, place of work, length of time at current position, family role, etc.), a schedule or calendar (i.e., the items listed thereon, time frames, etc.), projects (e.g., past, current, or future work-related projects), location (e.g., previous and/or current location and/or location relative to other users), social media activity (e.g., posts, reactions, comments, groups, etc.), browsing history (e.g., web pages visited), and online purchases.

The cognitive analysis may also include classifying natural language, analyzing tone, and analyzing sentiment (e.g., scanning for keywords, key phrases, etc.) with respect to, for example, communications sent to and/or received/detected by chatbots. In some embodiments, natural language processing (NLP), Mel-frequency cepstral coefficients (MFCCs), and/or region-based convolutional neural network (R-CNN) pixel mapping (e.g., for images/videos sent to chatbots), as are commonly understood, are used. Over time, the methods and systems described herein may determine correlations (or insights) between communications (e.g., voice and/or text-based communications) received by chatbots and data sources associated with the communications, perhaps with feedback provided by the users, that allows for the performance of the system to improve with continued use.

As such, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, the management of chatbot (or question answering system) operation as described herein. Utilizing the models, the performance (or operation) of the system (e.g., utilizing/based on new inputs) may be predicted and/or the performance of the system may be optimized by investigating how changes in the input(s) effect the output(s).

It should be understood that as used herein, the term “computing node” (or simply “node”) may refer to a computing device, such as a mobile electronic device or a desktop computer, and/or an application, such a chatbot, an email application, a social media application, a web browser, etc. In other words, as used herein, examples of computing nodes include, for example, computing devices such as mobile phones, tablet devices, desktop computers, or other devices, such as appliances (IoT appliances) that are owned and/or otherwise associated with individuals (or users), and/or various applications that are utilized by the individuals on such computing devices.

In particular, in some embodiments, a method for managing (or controlling) a chatbot (and/or the operation thereof) and/or answering questions utilizing multiple models by one or more processors is described. A plurality of models is received. Each of the plurality of models is associated with answering questions for a respective user. A weighting is assigned to each of the plurality of models. An answer to a question is generated based on the plurality of models and the weighting assigned to each of the plurality of models.

Each of the plurality of models may include at least one of synonyms, type information, and answer filters. Each of the plurality of users may be an individual. An indication of a selection of at least one of the weightings may be received.

A second weighting may be assigned to each of the plurality of models. An answer for a second question may be generated based on the plurality of models and the second weighting assigned to each of the plurality of models. The second question may be the same as the (first) question. The generated answer for the second question may be different than the generated answer for the (first) question.

The generating of the answer to the question may include generating a preliminary answer to the question based on each of the plurality of models and scoring each of the preliminary answers based on the weighting assigned to the respective model.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

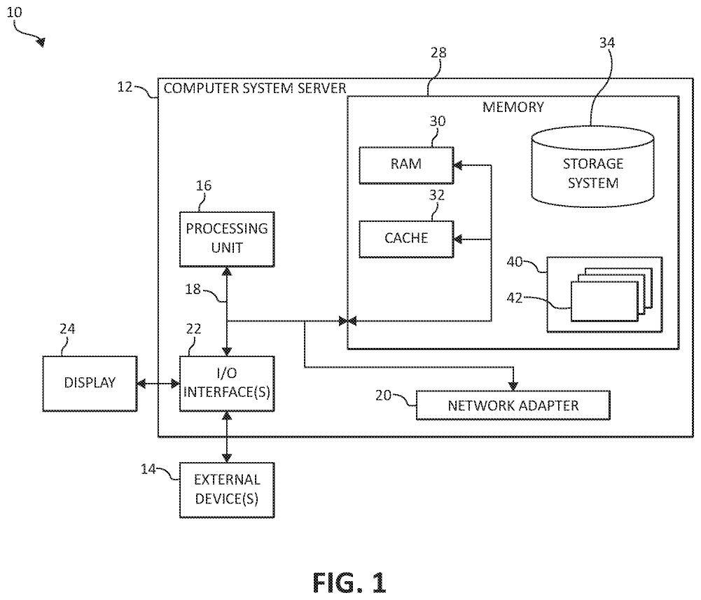

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc., and/or any other computing node utilizing a chatbot and/or in/through which a chatbot may be implemented. However, in some embodiments, some of the components depicted in FIG. 1 may be located in a computing device in, for example, a satellite, such as a Global Position System (GPS) satellite. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

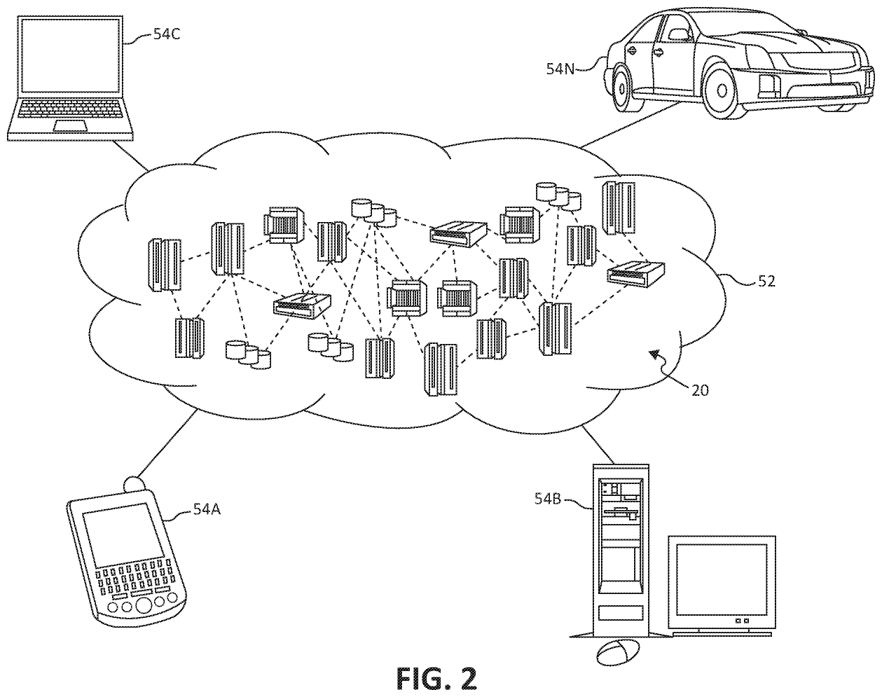

Referring now to FIG. 2, illustrative cloud computing environment 50 is depicted. As shown, cloud computing environment 50 comprises one or more cloud computing nodes 10 with which local computing devices used by cloud consumers, such as, for example, cellular (or mobile) telephone or PDA 54A, desktop computer 54B, laptop computer 54C, and vehicular computing system (e.g., integrated within automobiles, aircraft, watercraft, etc.) 54N, may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

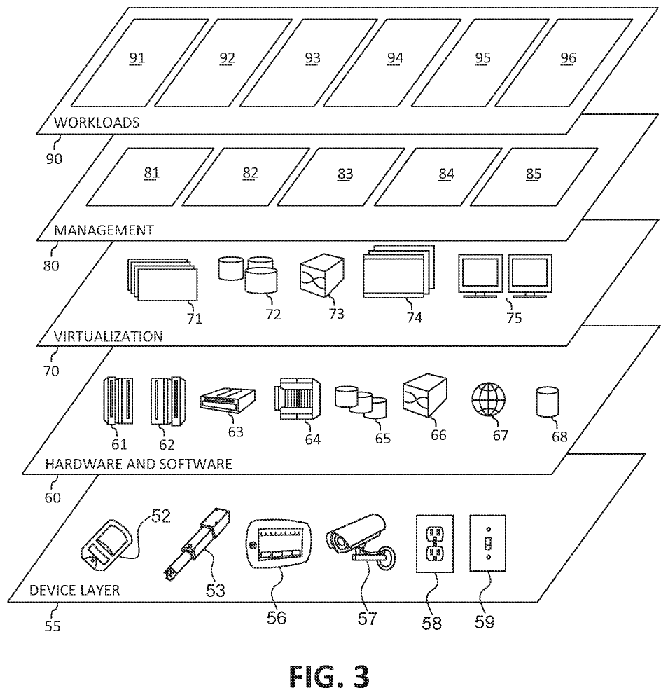

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator, washer/dryer, or air conditioning unit, and a wide variety of other possible interconnected devices/objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for managing chatbots (and/or the operation thereof) as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, in some embodiments, methods and/or systems for managing chatbots and/or question answering systems (and/or the operation thereof) are provided in which the user is able to identify (or select from) one or more available domain adaptation models (or adaptations models or simply “models”) to be utilized by the system when answering questions. In some embodiments, the user is able to assign a weight (or weighting) to each of the models (e.g., based on a predicted usefulness/helpfulness of each model). The system utilizes a combination of the models and/or uses the models in combination, along with the assigned weights thereof, to generate an answer to a question (or query) submitted by a user (i.e., a primary user).

In some embodiments, a user (e.g., a primary user) first selects or identifies which domain adaptation models (or models) they would like to utilize when interacting with (or using) the chatbot (or question answering) system. For example, when creating a user profile for or registering with the system, or perhaps via a system setting/preferences functionality, the user may be provided with a list of the available models, each of which may be associated with one or more other (or current, previous, etc.) users (e.g., users for which models have already been created).

In some embodiments, the models include (and/or are made of, based on, etc.) synonyms, type information, and answer filtering. Synonyms may be considered to include a list of tokens that make up an equivalence class. This equivalence class may be represented in a variety of ways, including the arbitrary selection of a single “canonical” form of the token with all other forms being “non-canonical.” Synonymy may be used in context dependent answer scoring, context independent answer scoring, and answer filtering subsets. Also, grammatical rules/categories may be implemented (e.g., the use of “modem” as a verb).

Type information may include types of tokens (e.g., “Spain” is a “country”) and hyponym-hypernym (subtype-supertype) denotations (e.g., “country” is a kind of “location”). Such may be used for “type coercion,” which may be a sub-step where candidate answers are evaluated against the specified type in a question, as will be appreciated by one skilled in the art. For example, in the question “What country borders France and Portugal?,” it may be desirable to evaluate whether a candidate answer is a country (as opposed to a city or individual).

Answer filtering may be represented as a “blacklist” of candidate answers that are not returned by the system (i.e., even if they are included in the “correct” answer). For example, offensive terms (e.g., vulgarity, racial slurs, etc.) may be filtered out and/or prevented from appearing in generated answers. As another example, other answers may be “down-weighted” to discourage their use. However, in some embodiments, this weighting may be overcome if there are indications that strongly indicate the token represents the correct answer. Depending on a particular engagement, however, the system may be customized in this respect. For example, answers representing certain parts of human anatomy may be filtered when the chatbot system is utilized in an environment with children (e.g., an elementary school) but not in an environment with adults (e.g., a medical school).

Models with such customizations may manually generated (e.g., explicitly created the respective users) and/or created via a cognitive analysis (e.g., based on the users' utilization of the system, cognitive profiles, etc.), stored (e.g., on any suitable memory device(s)), and made accessible by the question answering system (and/or a cognitive module). It should be understood that at least some of the models made available may include, utilize, and/or be based on the models of one or more other users (e.g., an available model associated with answering questions for User X may be include or utilize a model or customizations associated with answering questions for User Y and/or User Z).

As mentioned above, the primary user may be provided with a manner in which to select from the available models, which are then used to answer questions, as described below. For example, the available models (and/or the users associated with the models) may be provided to the user in a list, and the user may select their desired models in any suitable manner (e.g., via a user input device, such as a mouse, keyboard, touchscreen, etc.).

After selecting the desired models (which may or may not include a model of the primary user), a weight (or weighting) is assigned to each of the selected models. In some embodiments, an indication of the weighting for each model is received from the (primary) user (e.g., via any suitable user input device). For example, the user may provide a numeric value (e.g., between 0.0 and 1.0) for each of the selected models.

In some embodiments, when a question (or query) is received or detected (e.g., via voice command, text-based methods, etc.), the system generates an answer to (or for) the question based on (or utilizing) each of the selected models such that multiple, “preliminary” answers are generated. The system may score (or grade) each of the preliminary answers based on the weightings assigned to the selected models. For example, the system may determine or calculate a confidence score (or level, grade, etc.) for each preliminary answer based on the weightings. The system may select only particular preliminary answers based on the scores (e.g., the answer with the highest score, the top few answers, those with a score above a predetermined level, etc.) and provide (or return) the (final or cumulative) answer(s) to the user who submitted the question(s) (i.e., the primary user). For example, the user may be provided the answer via a voice response or text-based message (e.g., email, text message, pop-up window, etc.).

As an example of a scenario in which the methods and/or systems described herein may be utilized, consider a primary user (User 1) who has recently joined an investment firm workplace that utilizes a question answering system with the functionality described herein. In order to be able to optimize their use of the system as quickly as possible, the User 1 decides that they would like to utilize (or import) the domain adaptation models of two other users or employees (User 2 and User 3) at the workplace. User 1 may begin utilizing the system by, for example, creating a user profile (and/or beginning to generate a personalized/customized domain adaptation model).

During the process of creating the user profile, User 1 is presented with a list of the domain adaptation models that are available to/accessible by the system. User 1 selects the models associated with User 2 and User 3. User 1 understands that User 2 is significantly more experienced than User 3. As such, User 1 would like to weight the model of User 2 higher than that of User 3. For example, User 1 may assign the model of User 2 a weighting of 0.9, and assign the model of User 3, a weighting of 0.5. User 1 may also utilize (or select) their own model and assign it a weighting of 1.0 (and/or such may be done automatically/as a default setting). In such an example, three models are loaded into and/or utilized by the system. Specifically, User 1's model is weighted at 1.0, User 2's model is weighted at 0.9, and User 3's model is weighted at 0.5.

Continuing with this example, assume that User 2's model specifies that “QWE” refers to a well-known technology company that is headquartered in the United States (e.g., “QWE Technology”). Also assume that User 3, in a sincere but misguided attempt to be helpful, has specified in their model that “QWE” refers to non-profit organization associated with a recreational activity (e.g., “QWE Guild”). Because the workplace is associated with investments, the domain adaptation in User 3's model may be considered to be counterproductive.

User 1 then poses a question to the system (e.g., via voice command, keyboard, etc.), such as “What was QWE's revenue last year?” The system may analyze (and/or answer) the question utilizing the model of User 2 and the model of User 3. In particular, the (preliminary) answer generated using User 2's model may be “The revenue of QWE Technology last year was $80 billion.” The answer generated using User 3's model may be “The revenue of QWE Guild last year was $80,000.” However, it should be noted that the answers generated may include or recite, for example, only the portion of the name of the organizations included in the question as posed (e.g., “QWE”). It should also be noted that if the model of User 1 does not provide any information regarding the question, the model may not be utilized for answering the particular question.

Due to the nature of the workplace (e.g., an investment firm), the answer generated using the model of User 2 may be considered to be more relevant to the question posed by User 1. However, because the adaptation models of both User 2 and User 3 were utilized, the name (or acronym) “QWE” is resolved as a synonym for both “QWE Technology” and “QWE Guild.” In some embodiments described herein, in such a situation, the two synonyms (and/or the corresponding answers generated by the models) are weighted differently due to the different weightings assigned to the models. For example, a confidence score of 90% may be determined (or calculated) for “QWE Technology” (and/or the answer generated using the model of User 2 as a whole), which corresponds to the weighting assigned to User 2's model (e.g., 0.9). Likewise, a confidence score of 50% may be determined for “QWE Guild,” which corresponds to the weighting assigned to User 3's model (e.g., 0.5).

In some embodiments, context-dependent answer scorers are utilized to evaluate and assign scores to candidate answers (e.g., via a cognitive analysis). Using the scoring, in some embodiments, one (or more) of the generated preliminary answers is selected and returned or provided to the primary user (e.g., User 1) as a final answer. In the example described above, the revenue value of “$80 billion” would be assigned a higher score than “$80,000” and thus returned as a final answer to the primary user.

However, it should be noted that the answer returned to the primary user may change if different weightings are assigned to the models. For example, if a second set of weightings is assigned to the models such that the weighting of User 2's model is higher than that of the weighting of User 3's model, and a second question (i.e., the same question) is submitted to the system, the generated answer may include the preliminary answer generated using User 3's model (e.g., $80,000).

By allowing users (e.g., primary users) to assign weightings to the domain adaptation models available, the users are provided with the flexibility to utilize individual domain adaptations of other users without fear of unduly influencing the system with domain adaptation judgments from a less reliable source.

Additional details and examples regarding the application of weights to the domain adaptation models of user, which may be utilized by the methods and/or systems described herein, are described below.

Consider a situation in which the system is performing a type system lookup to determine if “QWE” is a “technology company,” and according to a first user's model (or a first model), QWE “is” a technology company, but according to a second user's model (or a second model), QWE is “not” a technology company (e.g., the first user and the second user are not primary users). The first model is assigned an overall weight of 0.8, and the second model is assigned an overall weight of 0.4.

In such an example, two features may be calculated: one representing whether or not a feature “is” the correct type, and another representing whether or not the feature is “not” the correct type (with neither feature specifying data on the topic). The type evaluation may be performed twice, once with each model. According to the first model, “yes_type=1.0” and “no_type=0.0.” According to the second model, “yes_type=0.0” and “no_type=1.0.”

Each of the feature values may then be weighted according to the weights of the respective models. Specifically, according to the first model, “yes_type=0.8=1.0×0.8” and “no_type=0.0=0.0×0.8.” According to the second model, “yes_type=0.0=0.0×0.4” and “no_type=0.4=1.0×0.4.”

The features may then be merged based on a maximum function. The raw feature values according to the system as a whole may be “yes_type=0.8” and “no_type=0.4.” The raw features values may then be provided to a machine learning system for evaluation (e.g., for training purposes or during utilization).

A similar methodology may be utilized for the output of a context dependent answer scoring algorithm (i.e., a method of evaluating how well a candidate answers a question given a supporting passage). Different values may be returned depending on what words are considered synonyms, which may vary depending on the content of the domain adaptation models. The different values may be multiplied by the weight of the model as a whole, and then presented to the machine learning system in the same way is done for the type example described above. As such, in an example in which the posed question is “What bill did Obama sign?,” and a returned answer (or passage) includes “BHO signed the ACA,” a model that correctly identifies “Obama” and “BHO” as synonyms may result in a higher raw output of a context dependent scorer.

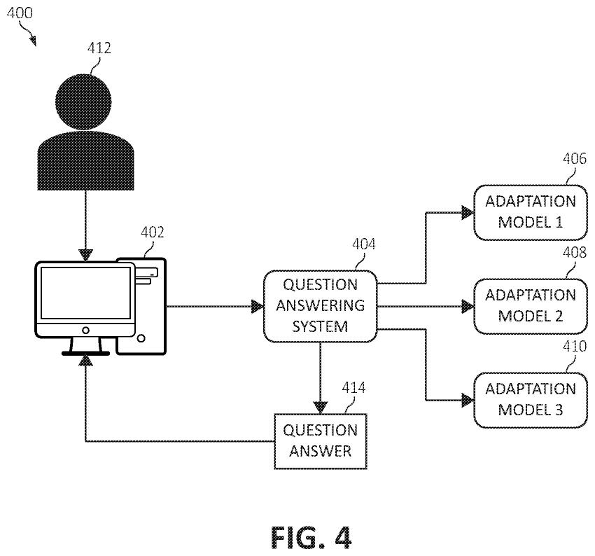

FIG. 4 illustrates an exemplary computing environment 400 in which the embodiments described herein may be implemented. In the depicted environment, the computing environment 400 includes a computing device 402, a question answering (and/or chatbot) system 404, and domain adaptation models (or adaptation models) 406, 408, and 410.

The computing device (or node) 402 may be any suitable computing device, such as those described above (e.g., a desktop PC, a mobile electronic device, etc.), which may be utilized by a user or individual (e.g., a primary user) 412 to, for example, interact with the question answering system 404. Although not shown in detail, the computing device 402 may include various user input devices that may be used by the user 412 to pose (or provide, submit, etc.) questions (or commands) to the question answering system, such as a microphone, a keyboard, mouse, touchscreen, etc., along with a display device and perhaps a speaker.

The question answering system 404 may be any suitable chatbot system that is configured to perform the functionality described herein. Although not shown, the question answering system 404 (and/or the computing device 402) may include a cognitive module configured to perform a cognitive analysis, machine learning technique, etc., such as those described above.

Each of the adaptation models 406-410 may be configured with (and/or include) customizations, adaptations, etc. associated with generating answers for particular, respective users (e.g., other users, the primary user, etc.), as described above. In the depicted embodiment, the environment 400 includes three adaptation models 406-410. However, it should be understood that in other embodiments a different number of adaptation models (i.e., more or less) may be available to and/or accessible by the question answering system (and/or the computing device 402 and/or the primary user 412).

In some embodiments, the computing device 402, the question answering system 404, and/or the adaptation modules 406-410 may be integrated into common computing devices and/or locally implemented. For example, the question answering system 404 may be integrated within the computing device 402, and/or the adaptation models 406-410 may be stored on and/or loaded onto the question answering system 404 and/or the computing device 402 (i.e., memory devices therein). However, in some embodiments, the components shown in FIG. 4 may be remote from each other and in operable communication via any suitable communication network (e.g., the Internet).

As described above, the user may access the question answering system 404 via the computing device 402 (e.g., while creating a user profile, registering, etc.) and select one or more of the adaptation models 406-410 to be utilized by the question answering system 404 when answering questions, as well as assign a weighting to each of the selected adaptation models 406-410. The primary user 412 may then submit one or more question to the question answering system 404 via the computing device 402 (e.g., via a keyboard, microphone, etc.). The question answering system 404 may then utilize the selected adaptation models 406-410 to generate an answer(s) 414 to the submitted question and provide the (final) answer(s) to the primary user 412 via the computing device 402 (e.g., via a display screen, speaker, etc.), as described above.

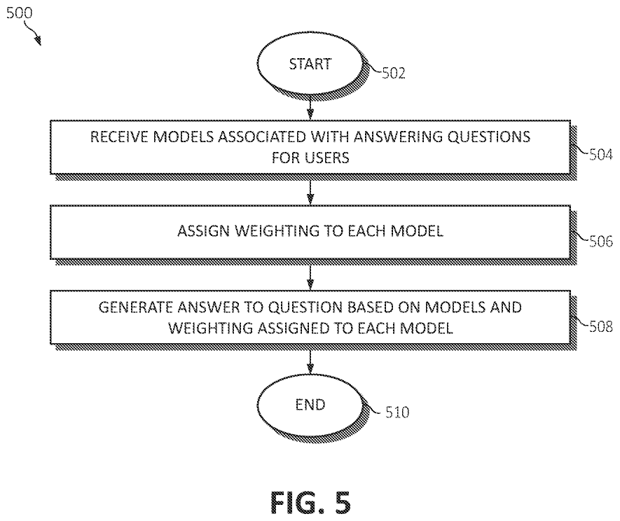

Turning to FIG. 5, a flowchart diagram of an exemplary method 500 for managing (or controlling) a chatbot or question answering system (and/or the operation thereof) and/or answering questions utilizing multiple models, in accordance with various aspects of the present invention, is provided. Method 500 begins (step 502) with, for example, a chatbot (or question answering system) being implemented within a suitable computing device, such as a desktop PC, mobile electronic device, etc.

A plurality of models (or domain adaptation models) is received (or retrieved) (step 504). Each of the plurality of models is associated with answering questions for a respective user. Each of the plurality of models may include at least one of synonyms, type information, and answer filters, and each of the users may be an individual (e.g., a primary user or other users). The plurality of models may be selected based on an indication received from a user (e.g., the user may provide input indicating a selection of particular ones of the available models).

A weighting is assigned to each of the plurality of models (step 506). The weighting assigned to each of the models may be based on an indication of a selection of at least one of the weightings received from a user (e.g., the primary user).

An answer to a question (e.g., received from the primary user) is generated based on the plurality of models and the weighting assigned to each of the plurality of models (step 508). The generating of the answer to the question may include generating a preliminary answer to the question based on each of the plurality of models and scoring each of the preliminary answers based on the weighting assigned to the respective model.

Method 500 ends (step 510) with, for example, the generated (final) answer being provided to the user (i.e., the primary user) via (e.g., rendered by) a suitable computing device (e.g., the computing utilized by the primary user to submit the question) via, for example, a voice response, being displayed on a display device, provided via electronic communication, etc. The process may be repeated when the selected models are change, the weightings are changed, and/or a subsequent question is received. For example, a second weighting may be assigned to each of the plurality of models. An answer for a second question may be generated based on the plurality of models and the second weighting assigned to each of the plurality of models. The second question may be the same as the (first) question. The generated answer for the second question may be different than the generated answer for the (first) question. In some embodiments, the user(s) may provide feedback related to the management of the question answering system, which may be utilized by the system to improve performance over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for answering questions utilizing multiple models, by one or more processors, comprising:
receiving a plurality of models, wherein each of the plurality of models is associated with answering questions for a respective user;
assigning a weighting to each of the plurality of models; and
generating an answer to a question based on the plurality of models and the weighting assigned to each of the plurality of models.

2. The method of claim 1, wherein each of the plurality of models includes at least one of synonyms, type information, and answer filters.

3. The method of claim 1, further comprising:
assigning a second weighting to each of the plurality of models; and
generating an answer for a second question based on the plurality of models and the second weighting assigned to each of the plurality of models.

4. The method of claim 3, wherein the second question is the same as the question, and the generated answer for the second question is different than the generated answer for the question.

5. The method of claim 1, wherein the generating of the answer to the question comprises generating a preliminary answer to the question based on each of the plurality of models and scoring each of the preliminary answers based on the weighting assigned to the respective model.

6. The method of claim 1, further comprising receiving an indication of a selection of at least one of the weightings.

7. The method of claim 1, wherein each of said plurality of users is an individual.

8. A system for answering questions utilizing multiple models comprising:
a processor executing instructions stored in a memory device, wherein the processor:
receives a plurality of models, wherein each of the plurality of models is associated with answering questions for a respective user;
assigns a weighting to each of the plurality of models; and
generates an answer to a question based on the plurality of models and the weighting assigned to each of the plurality of models.

9. The system of claim 8, wherein each of the plurality of models includes at least one of synonyms, type information, and answer filters.

10. The system of claim 8, wherein the processor further:
assigns a second weighting to each of the plurality of models; and
generates an answer for a second question based on the plurality of models and the second weighting assigned to each of the plurality of models.

11. The system of claim 10, wherein the second question is the same as the question, and the generated answer for the second question is different than the generated answer for the question.

12. The system of claim 8, wherein the generating of the answer to the question comprises generating a preliminary answer to the question based on each of the plurality of models and scoring each of the preliminary answers based on the weighting assigned to the respective model.

13. The system of claim 8, wherein the processor further receives an indication of a selection of at least one of the weightings.

14. The system of claim 8, wherein each of said plurality of users is an individual.

15. A computer program product for answering questions utilizing multiple models, by a processor, the computer program product embodied on a non-transitory computer-readable storage medium having computer-readable program code portions stored therein, the computer-readable program code portions comprising:
an executable portion that receives a plurality of models, wherein each of the plurality of models is associated with answering questions for a respective user;
an executable portion that assigns a weighting to each of the plurality of models; and
an executable portion that generates an answer to a question based on the plurality of models and the weighting assigned to each of the plurality of models.

16. The computer program product of claim 15, wherein each of the plurality of models includes at least one of synonyms, type information, and answer filters.

17. The computer program product of claim 15, wherein the computer-readable program code portions further include:
an executable portion that assigns a second weighting to each of the plurality of models; and
an executable portion that generates an answer for a second question based on the plurality of models and the second weighting assigned to each of the plurality of models.

18. The computer program product of claim 17, wherein the second question is the same as the question, and the generated answer for the second question is different than the generated answer for the question.

19. The computer program product of claim 15, wherein the generating of the answer to the question comprises generating a preliminary answer to the question based on each of the plurality of models and scoring each of the preliminary answers based on the weighting assigned to the respective model.

20. The computer program product of claim 15, wherein the computer-readable program code portions further include an executable portion that receives an indication of a selection of at least one of the weightings.

21. The computer program product of claim 15, wherein each of said plurality of users is an individual.
